(19) United States
(12) Patent Application Publication
(10) Pub. No.: US 2009/0074094 A1
(43) Pub. Date: Mar. 19, 2009

(54) BEACON SYMBOLS WITH MULTIPLE ACTIVE SUBCARRIERS FOR WIRELESS COMMUNICATION

(75) Inventors: Ravi Palanki, San Diego, CA (US); Avneesh Agrawal, San Diego, CA (US); Alexei Gorokhov, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/206,533

(22) Filed: Sep. 8, 2008

Related U.S. Application Data
(60) Provisional application No. 60/972,539, filed on Sep. 14, 2007.

(51) Int. Cl. H04L 27/00; H04L 27/28

(52) U.S. Cl. 375/260; 375/299

(57) ABSTRACT

Techniques for transmitting information using beacon symbols in a wireless communication system are described. In one design, a transmitter may map information to multiple subcarriers among a plurality of subcarriers, with the information being conveyed by the position of the multiple subcarriers. The transmitter may map the information to at least one non-binary symbol. The transmitter may then determine each of the multiple subcarriers based on one non-binary symbol or may determine all of the multiple subcarriers based on one non-binary symbol. The transmitter may generate a beacon symbol having the information mapped to the multiple subcarriers. The transmitter may use higher transmit power for the multiple subcarriers to allow receivers with low geometry to reliably receive the information. The use of multiple subcarriers may allow more information to be sent in the beacon symbol and may also improve frequency diversity.

The present application claims priority to provisional U.S. Application Ser. No. 60/972,539, entitled “MULTI-BEACON OFDM SYMBOL,” filed Sep. 14, 2007, assigned to the assignee hereof and incorporated herein by reference.

### BACKGROUND

I. Field

The present disclosure relates generally to communication, and more specifically to techniques for transmitting information in a wireless communication system.

II. Background

Wireless communication systems are widely deployed to provide various communication content such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include a number of base stations that can support communication for a number of terminals. A base station may transmit various types of information such as traffic data, control information, and pilot to one or more terminals. Control information may also be referred to as overhead information, signaling, etc. A terminal may also transmit various types of information to a base station. It is desirable for a transmitter to efficiently and reliably transmit information to one or more receivers.

### SUMMARY

Techniques for transmitting information using beacon symbols in a wireless communication system are described herein. In one design, a transmitter may map information (e.g., a cell identifier (ID), a sector ID, and/or other information) to multiple subcarriers among a plurality of subcarriers, with the information being conveyed by the position of the multiple subcarriers. The transmitter may generate a beacon symbol comprising the information mapped to the multiple subcarriers. The beacon symbol may be an orthogonal frequency division multiplex (OFDM) symbol or a single-carrier frequency division multiplex (SC-FDM) symbol.

In one design, the transmitter may map the information to at least one non-binary symbol. The transmitter may then determine the multiple subcarriers based on the at least one non-binary symbol. In one design, the system bandwidth may be partitioned into multiple segments, and one subcarrier in each segment may be selected based on one non-binary symbol. In another design, the multiple subcarriers may be selected based on one non-binary symbol. In general, the beacon symbol may carry one or more non-binary symbols for one or more messages.

The transmitter may use higher transmit power for the multiple subcarriers. This may allow receivers with low geometry to reliably receive the information sent by the transmitter. The use of multiple subcarriers may allow more information to be sent in the beacon symbol and may also improve frequency diversity.

Various aspects and features of the disclosure are described in further detail below.

### BRIEF DESCRIPTION OF THE DRAWINGS

FIG. 1 shows a wireless communication system.

FIGS. 2 and 3 show two designs of beacon symbols with multiple active subcarriers.

FIGS. 4 and 5 show transmit power versus subcarrier for one beacon symbol without and with additional information, respectively.

FIG. 6 shows a process for transmitting information using beacon symbol.

FIG. 7 shows an apparatus for transmitting information using beacon symbol.

FIG. 8 shows a process for receiving information sent in beacon symbol.

FIG. 9 shows an apparatus for receiving information sent in beacon symbol.

FIG. 10 shows a block diagram of a base station and a terminal.

### DETAILED DESCRIPTION

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). cdma2000 and UMB are described in documents from an organization named “3rd Generation Partnership Project 2” (3GPP2).

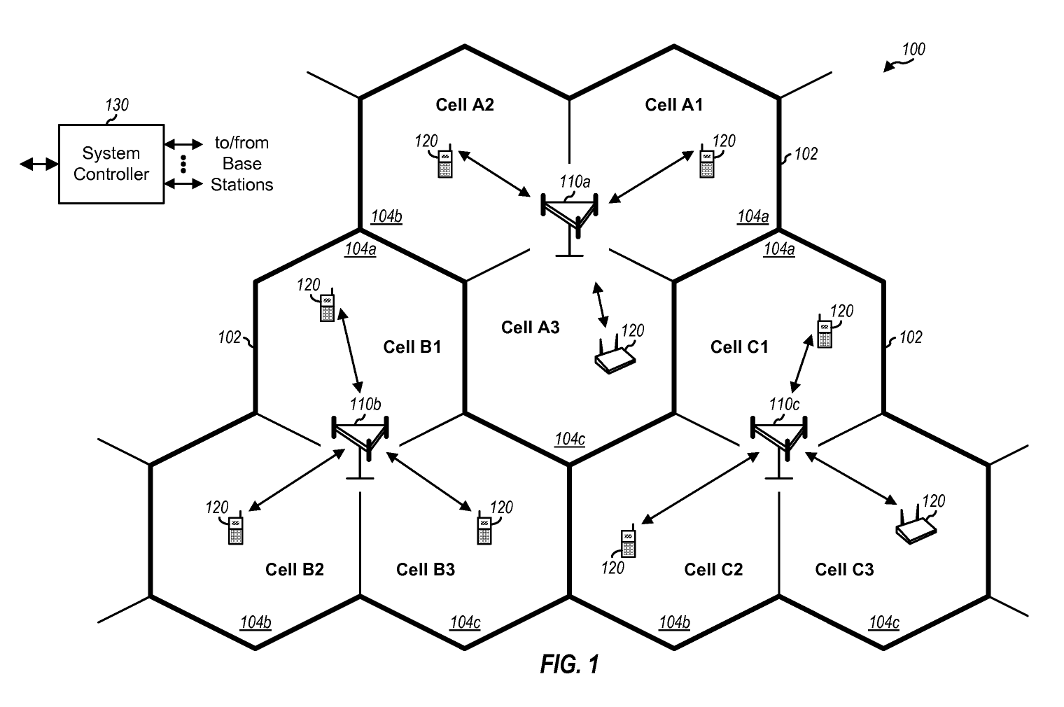

FIG. 1 shows a wireless communication system 100, which may include a number of base stations and other network entities. For simplicity, only three base stations 110a, 110b and 110c and one system controller 130 are shown in FIG. 1. A base station may be a fixed station that communicates with the terminals and may also be referred to as a Node B, an evolved Node B (eNB), an access point, a base transceiver station (BTS), etc. Each base station 110 provides communication coverage for a particular geographic area 102. To improve system capacity, the overall coverage area of a base station may be partitioned into multiple smaller areas, e.g., three smaller areas 104a, 104b and 104c. Each smaller area may be served by a respective base station subsystem. In 3GPP, the term “cell” can refer to the smallest coverage area of a base station and/or a base station subsystem serving this coverage area. In 3GPP2, the term “sector” can refer to the smallest coverage area of a base station and/or a base station subsystem serving this coverage area. For clarity, 3GPP concept of cell is used in the description below.

In the example shown in FIG. 1, each base station 110 has three cells that cover different geographic areas. For simplicity, FIG. 1 shows the cells not overlapping one another. In a practical deployment, adjacent cells typically overlap one another at the edges, which may allow a terminal to receive communication coverage from one or more cells at any location as the terminal moves about the system.

Terminals 120 may be dispersed throughout the system, and each terminal may be stationary or mobile. A terminal may also be referred to as a mobile station, a user equipment (UE), an access terminal, a subscriber unit, a station, etc. A terminal may be a cellular phone, a personal digital assistant (PDA), a wireless modem, a wireless communication device, a handheld device, a laptop computer, a cordless phone, etc. A terminal may communicate with a base station via the forward and reverse links. The forward link (or downlink) refers to the communication link from the base station to the terminal, and the reverse link (or uplink) refers to the communication link from the terminal to the base station.

System controller 130 may couple to a set of base stations and provide coordination and control for these base stations. System controller 130 may be a single network entity or a collection of network entities.

System 100 may utilize OFDM and/or SC-FDM. OFDM and SC-FDM partition the system bandwidth into multiple (K) orthogonal subcarriers, which are also commonly referred to as tones, bins, etc. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 MHz, respectively. A subset of the K total subcarriers may be usable for transmission, and the remaining subcarriers may serve as guard subcarriers. For simplicity, the following description assumes that all K total subcarriers are usable.

The techniques described herein may be used with OFDM, SC-FDM, and possibly other modulation techniques. In general, modulation symbols are sent in the frequency domain with OFDM and in the time domain with SC-FDM. For clarity, much of the description below assumes that the system utilizes OFDM and that information is sent in OFDM symbols. However, references to OFDM symbols in the description below may be replaced with SC-FDM symbols or some other transmission symbols.

A transmitter may transmit beacon symbols to one or more receivers. A beacon symbol is an OFDM symbol or an SC-FDM symbol that carries information in the position of one or more subcarriers, which are referred to as beacon subcarriers or active subcarriers. For example, one bit of information may be used to select one of two subcarriers, two bits of information may be used to select one of four subcarriers, etc. Information is thus conveyed in which subcarriers are used as the beacon subcarriers instead of modulation symbols sent on the subcarriers. A beacon symbol may also be referred to as a beacon OFDM symbol, a beacon, etc. A beacon symbol may be transmitted using higher transmit power for the beacon subcarrier(s) and may thus be reliably detected even at low received signal quality. In the following description, signal-to-noise ratio (SNR) is used to denote received signal quality.

In an aspect, a beacon symbol may comprise information mapped to multiple beacon subcarriers. Information conveyed by the position of the beacon subcarriers is referred to as beacon information. The use of multiple beacon subcarriers may provide certain advantages. First, more information may be sent using multiple beacon subcarriers instead of a single beacon subcarrier in a beacon symbol. This may improve the dimension of a beacon symbol. Second, frequency diversity may be improved by using multiple beacon subcarriers instead of one beacon subcarrier. The improved frequency diversity may result in more reliable reception of beacon information under frequency selective fading, which is a frequency response that varies across frequency.

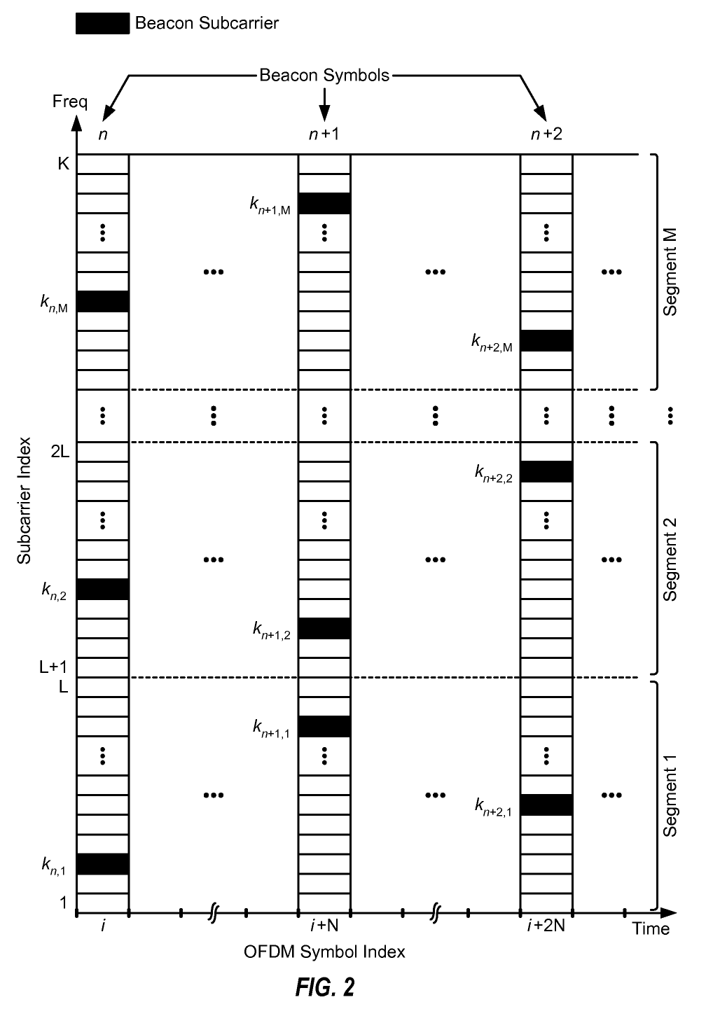

FIG. 2 shows a design of beacon symbols with multiple beacon subcarriers. In this design, the system bandwidth may be partitioned into M segments, and each segment may include L subcarriers, where L and M may each be any integer value greater than one. In one design, the system bandwidth may be partitioned into multiple subbands, and each subband may include a set of contiguous or non-contiguous subcarriers. Each segment may cover one or more subbands. In another design, the system may support operation on multiple carriers, and each segment may correspond to a different carrier.

In general, any number of segments may be defined, and each segment may include any number of subcarriers. The M segments may include the same or different numbers of subcarriers. The M segments may be assigned static sets of subcarriers or different sets of subcarriers in different time intervals. In any case, the subcarriers in each segment may be known a priori by both a transmitter and a receiver, or conveyed via broadcast information, or provided in some other manners. For simplicity, the following description assumes that each segment is assigned a static set of L subcarriers.

A beacon symbol may be sent in every N-th OFDM symbol periods, where N may be an integer value of one or greater. In one design, the transmission timeline may be partitioned into units of frames, with each frame including N OFDM symbol periods. A beacon symbol may be sent in one OFDM symbol period of each frame. The frames may be radio frames, physical layer (PHY) frames, super-frames, etc. A beacon symbol may also be sent in each OFDM symbol period with N=1.

In the example shown in FIG. 2, a beacon symbol is sent in OFDM symbol period i, where i is an index for OFDM symbol period. This beacon symbol includes one beacon subcarrier in each of the M segments. The M beacon subcarriers in this beacon symbol have indices of k_{n,m}, for m=1, . . . , M, where n is an index for beacon symbol, and m is an index for segment. The beacon symbol may or may not carry additional information on the remaining subcarriers. An OFDM symbol containing any information may be sent in each of OFDM symbol periods i+1 through i+N−1. Another beacon symbol is sent in OFDM symbol period i+N and includes one beacon subcarrier in each of the M segments. The M beacon subcarriers in this beacon symbol have indices of k_{n+1,m}, for m=1, . . . , M. This beacon symbol may or may not carry additional information on the remaining subcarriers. Beacon symbols and OFDM symbols may be sent in other OFDM symbol periods in similar manner.

A beacon subcarrier index k_{n,m} for segment m in beacon symbol n may be considered as a non-binary symbol. A non-binary symbol is a symbol having one of more than two possible values and may also be referred to as a multi-bit symbol. For example, if L=64, then a 6-bit symbol having one of 64 possible values may be used to select one of 64 possible subcarriers as the beacon subcarrier. L may or may not be a power of two. In any case, M non-binary symbols may be used to select M beacon subcarriers in the M segments in one beacon symbol. The use of M beacon subcarriers in one beacon symbol may thus improve the dimension of the beacon symbol.

Beacon information may be sent in beacon symbols in various manners. In one design, a message comprising beacon information may be encoded to generate M non-binary symbols, which may be used to select M beacon subcarriers in one beacon symbol. In this design, a beacon symbol may carry non-binary symbols for one message, which may allow for quick reception of the message. In another design, M messages may be encoded to generate M sequences of non-binary symbols. Each sequence of non-binary symbols may be sent on beacon subcarriers (in different beacon symbols) in one segment. A given beacon symbol may include M beacon subcarriers determined by M non-binary symbols in the M sequences for the M messages. This design may provide time diversity for each message. In general, a beacon symbol may carry non-binary symbols for one or more messages. Each message may have one or more non-binary symbols sent in the beacon symbol.

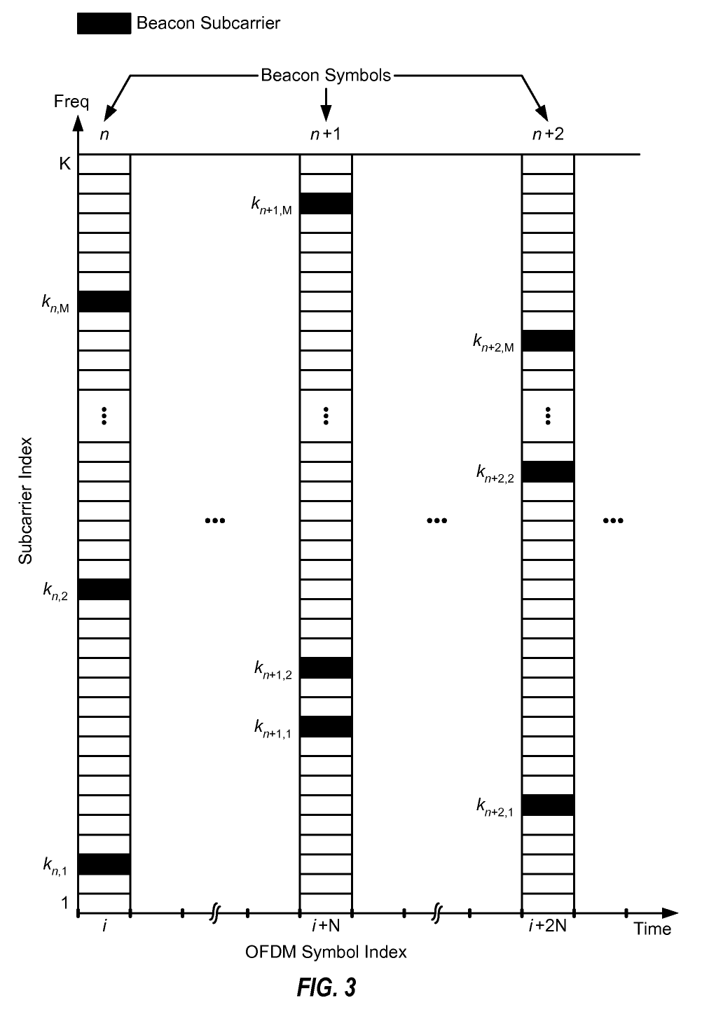

FIG. 3 shows another design of beacon symbols with multiple beacon subcarriers. In this design, a beacon symbol includes M different beacon subcarriers, and each beacon subcarrier may be located anywhere within the system bandwidth. A beacon symbol may be sent in every N-th OFDM symbol periods, where N≧1. In the example shown in FIG. 3, a beacon symbol is sent in OFDM symbol period i. This beacon symbol includes M beacon subcarriers with indices of k_{n,m}, for m=1, . . . , M, and may or may not carry additional information on the remaining subcarriers. An OFDM symbol containing any information may be sent in each of OFDM symbol periods i+1 through i+N−1. Another beacon symbol is sent in OFDM symbol period i+N. This beacon symbol includes M beacon subcarriers with indices of k_{n+1,m}, for m=1, . . . , M, and may or may not carry additional information on the remaining subcarriers. Beacon symbols and OFDM symbols may be sent in other OFDM symbol periods in similar manner.

In one design, each beacon subcarrier in a beacon symbol may be selected by one non-binary symbol. In this design, M non-binary symbols may be sent in one beacon symbol. There may be restrictions on the range of possible values for each non-binary symbol. The M non-binary symbols may be for one or more messages. In another design, the M beacon subcarriers in a beacon symbol may be selected by a single non-binary symbol. In this design, each possible combination of M beacon subcarriers may correspond to one possible value of the non-binary symbol. More combinations of beacon subcarriers may be formed with more beacon subcarriers. Hence, a larger non-binary symbol with more bits may be sent with more beacon subcarriers.

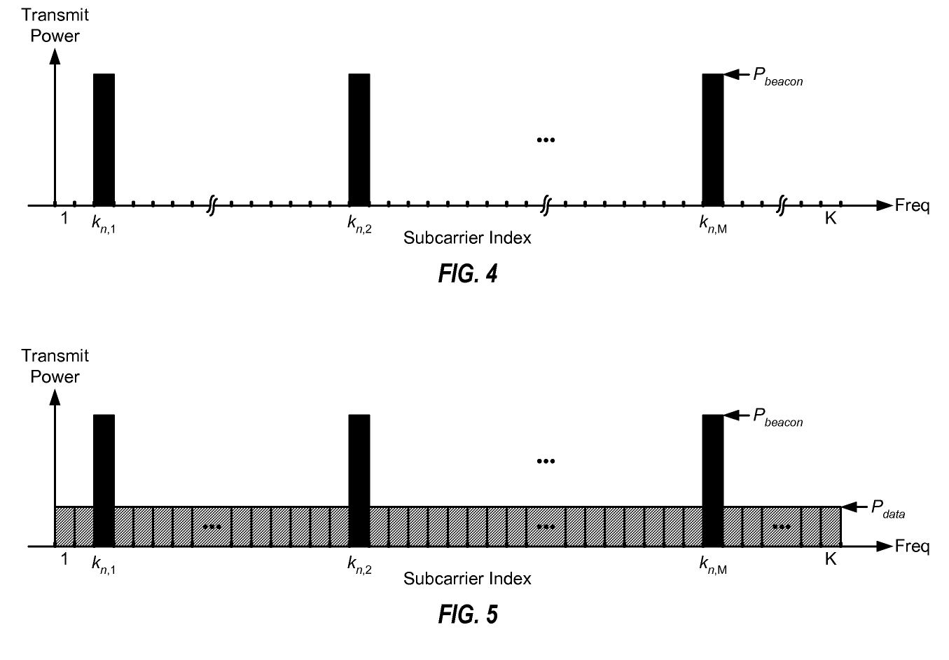

FIG. 4 shows a plot of transmit power versus subcarrier for one beacon symbol comprising only beacon subcarriers. The terms “transmit power” and “energy” are related and are often used interchangeably. The available transmit power Pₐᵥₐᵢₗ for an OFDM symbol may be distributed across the M beacon subcarriers. In the example shown in FIG. 4, the available transmit power is distributed uniformly across the M beacon subcarriers, and each beacon subcarrier is transmitted at a transmit power level of P_{beacon}=Pₐᵥₐᵢₗ/M. The remaining subcarriers may be blanked and may have a transmit power level of zero.

FIG. 5 shows a plot of transmit power versus subcarrier for one beacon symbol comprising beacon subcarriers as well as additional information. The available transmit power Pₐᵥₐᵢₗ for an OFDM symbol may be split into beacon transmit power P_{b} and data transmit power P_{d}. The beacon transmit power is the fraction of the available transmit power that is allocated for beacon information. The data transmit power is the fraction of the available transmit power that is allocated for the additional information. In the example shown in FIG. 5, the beacon transmit power is distributed uniformly across the M beacon subcarriers, and each beacon subcarrier is transmitted at a transmit power level of P_{beacon}=P_{b}/M.

The data transmit power may be distributed across the subcarriers used to send the additional information. In the example shown in FIG. 5, the data transmit power is distributed uniformly across the W=K−M remaining subcarriers, and each subcarrier is transmitted at a transmit power level of P_{data}=P_{d}/W. In general, one or more types of information may be sent on the W remaining subcarriers, and the same or different transmit power levels may be used for different types of information. For example, pilot, control information, and traffic data may be sent on the W remaining subcarriers. Pilot may be sent at a first transmit power level, control information may be sent at a second transmit power level, and traffic data may be sent at a third transmit power level. The first transmit power level may be adjusted with a power control loop to achieve the desired received signal quality for pilot. The second transmit power level may be adjusted to achieve the desired reliability for control information. The third transmit power level may be dependent on the remaining data transmit power.

Since beacon information is conveyed by the position of the beacon subcarriers, any modulation symbol may be sent on each beacon subcarrier. However, sending the same modulation symbol or randomly selected modulation symbols on the M beacon subcarriers in one beacon symbol may result in a high peak-to-average-power ratio (PAPR) for the beacon symbol. PAPR is the ratio of peak power to average power for a waveform. High PAPR may result from possible in-phase addition of M sinusoidals for the M beacon subcarriers. High PAPR may cause a transmitter to be operated with a larger backoff for a power amplifier in order to avoid saturation and may thus degrade performance. High PAPR may be mitigated in various manners.

In one design, a set of M modulation symbols may be selected for the M beacon subcarriers to obtain reduced PAPR for a beacon symbol. For example, a beacon symbol may include three beacon subcarriers with indices of k₁=k_{c}−Δk, k₂=k_{c}, and k₃=k_{c}+Δk, where k_{c} is the index of the center beacon subcarrier, and Δk is the spacing between beacon subcarriers. Three sinusoidals exp(j2π·t·fₘ), for m=1, 2, 3, for the three beacon subcarriers k₁, k₂ and k₃ may be modulated with phases of f₁=−1, f₂=1, and f₃=1. These phases may result in a lower PAPR for the beacon symbol than other choices of phases. In general, a suitable set of M modulation symbols may be selected for each combination of M beacon subcarriers.

A beacon symbol may be generated with OFDM as follows. M modulation symbols may be mapped to M beacon subcarriers. Zero symbols with signal value of zero and/or other modulation symbols may be mapped to the remaining subcarriers. K mapped symbols may be transformed to the time domain with a K-point inverse fast Fourier transform (IFFT) to obtain a useful portion containing K time-domain samples. The last C samples of the useful portion may be copied and appended to the front of the useful portion to form an OFDM symbol containing K+C samples. The copied portion is referred to as a cyclic prefix, and C is the cyclic prefix length. The cyclic prefix is used to combat inter-symbol interference (ISI) caused by frequency selective fading. The OFDM symbol may be provided as a beacon symbol and may be transmitted in one OFDM symbol period, which may be K+C sample periods.

In another design, a beacon symbol with multiple beacon subcarriers may be generated with interleaved frequency division multiplexing (IFDM), which is one form of SC-FDM. For this design, M modulation symbols may be transformed with an M-point discrete Fourier transform (DFT) to obtain M frequency-domain symbols. The M frequency-domain symbols may be mapped to the M beacon subcarriers, and zero symbols and/or other modulation symbols may be mapped to the remaining subcarriers. K mapped symbols may be transformed with a K-point IFFT to obtain a useful portion. A cyclic prefix may be appended to the useful portion to form an SC-FDM symbol containing K+C samples. The SC-FDM symbol may be provided as a beacon symbol and may be transmitted in one OFDM symbol period.

A beacon symbol with multiple beacon subcarriers may also be generated in other manners to obtain a lower PAPR.

In general, beacon information may comprise any type of information, which may be dependent on whether a transmitter is a base station or a terminal. If the transmitter is a base station, then the beacon information may comprise a cell ID or a sector ID, broadcast information, system information, control information, etc. If the transmitter is a terminal, then the beacon information may comprise control information, etc.

Beacon information may be sent using a beacon code. A beacon code is a code used for encoding beacon information at a transmitter and for decoding beacon information at a receiver. A transmitter may process beacon information based on a beacon code to generate a sequence of non-binary symbols. The transmitter may send the non-binary symbols in one or more beacon symbols. A receiver may receive non-binary symbols from the one or more beacon symbols. The receiver may decode the received non-binary symbols based on the beacon code to recover the beacon information sent by the transmitter.

A beacon code may be defined based on a polynomial code, a maximum distance separable (MDS) code, a Reed-Solomon code (which is one type of MDS code), or some other type of code. For clarity, a specific beacon code based on a Reed-Solomon code is described below. For this beacon code, a non-binary symbol has one of S=47 possible values of 0 through 46. For the design shown in FIG. 2, each non-binary symbol value may be used to select one subcarrier in one segment, and S may be equal to or less than L. For the design shown in FIG. 3, each non-binary symbol value may be used to select a combination of M beacon subcarriers, and S may be equal to or less than the total number of combinations of the M beacon subcarriers. In general, a non-binary symbol may be used to select one or more beacon subcarriers, and S may be dependent on the number of combinations of all beacon subcarriers selected by the non-binary symbol.

In the example beacon code design, beacon information is sent in a 12-bit message. The beacon code should support at least 2¹²=4096 different sequences of non-binary symbols. Each possible message may be mapped to a different sequence of non-binary symbols.

A message comprising beacon information may be mapped to a sequence of non-binary symbols Xₜ(α₁, α₂, α₃), which may be expressed as:

Xₜ(α₁,α₂,α₃)=p₁^{α}^{₁}^{+2t}⊕p₁^{α}^{₂}p₂^{2t}⊕p₁^{α}^{₃}p₃^{2t}, Eq (1)

where t=0, 1, 2, . . . is an index for the non-binary symbols in the sequence,

p₁ is a primitive element of field Z₄₇, p₂=p₁², and p₃=p₁³,

α₁, α₂ and α₃ are exponent factors determined based on the message, and

⊕ denotes modulo addition.

Field Z₄₇ contains 47 elements from 0 through 46. A primitive element of field Z₄₇ is an element of Z₄₇ that may be used to generate all 46 non-zero elements of Z₄₇. As an example, for field Z₇ containing 7 elements from 0 through 6, 5 is a primitive element of Z₇ and may be used to generates all 6 non-zero elements of Z₇ as follows: 5⁰ mod 7=1, 5¹ mod 7=5, 5² mod 7=4, 5³ mod 7=6, 5⁴ mod 7=2, and 5⁵ mod 7=3.

In equation (1), arithmetic operations are over field Z₄₇. For example, addition of A and B may be given as (A+B) mod 47, multiplication of A with B may be given as (A*B) mod 47, A raised to the power of B may be given as A^{B} mod 47, etc. Additions within exponents are modulo-47 integer additions.

In one design, p₁=45, p₂=p₁²=4, and p₃=p₁³39. Other primitive elements may also be used for p₁. The selection of p₂=p₁² and p₃=p₁³ results in a Reed-Solomon code with equation (1).

The exponent factors α₁, α₂, α₃ may be defined as:

0≦α₁<2,

0≦α₂<46, and

0≦α₃<46. Eq (2)

A total of 2*46*46=4232 different combinations of α₁, α₂ and α₃ may be obtained with the constraints shown in equation set (2). Each unique combination of α₁, α₂ and α₃ corresponds to a different possible message and hence a different sequence of non-binary symbols for the beacon information. The 4232 different combinations of α₁, α₂ and α₃ can support a 12-bit message. A message may be mapped to a corresponding combination of α₁, α₂ and α₃, as follows:

Y=2116*α₁+46*α₂+α₃, Eq (3)

where Y is a 12-bit message value and is within a range of 0 to 4095. Other mappings between a message and a combination of α₁, α₂ and α₃ may also be used.

Since pᵢ⁴⁶=1, for i=1, 2, 3, the beacon code shown in equation (1) is periodic with a period of 46/2=23 symbols. Hence, Xₜ₊₂₃(α₁, α₂, α₃)=Xₜ(α₁, α₂, α₃) for any given value of t.

A transmitter may map a 12-bit message to a sequence of 23 non-binary symbols based on the beacon code shown in equation (1). The transmitter may send three or more consecutive non-binary symbols in the sequence for the message. Each non-binary symbol may be used to select (i) one beacon subcarrier in one segment for the design shown in FIG. 2 or (ii) one or more beacon subcarriers for the design shown in FIG. 3.

A receiver can recover the message sent by the transmitter with three consecutive non-binary symbols. The receiver may obtain three non-binary symbols x₁, x₂ and x₃ for t, t+1 and t+2, respectively. The received non-binary symbols may be expressed as:

$${x}_{1} = {p}_{1}^{{α}_{1} + 2 t} ⊕ {p}_{1}^{{α}_{2}} {p}_{2}^{2 t} ⊕ {p}_{1}^{{α}_{3}} {p}_{3}^{2 t} , \\ {x}_{2} = {p}_{1}^{{α}_{1} + 2 ( t + 1 )} ⊕ {p}_{1}^{{α}_{2}} {p}_{2}^{2 ( t + 1 )} ⊕ {p}_{1}^{{α}_{3}} {p}_{3}^{2 ( t + 1 )} \\ = {p}_{1}^{2} {p}_{1}^{{α}_{1} + 2 t} ⊕ {p}_{2}^{2} {p}_{1}^{{α}_{2}} {p}_{2}^{2 t} ⊕ {p}_{3}^{2} {p}_{1}^{{α}_{3}} {p}_{3}^{2 t} , \\ and \\ {x}_{3} = {p}_{1}^{{α}_{1} + 2 ( t + 2 )} ⊕ {p}_{1}^{{α}_{2}} {p}_{2}^{2 ( t + 2 )} ⊕ {p}_{1}^{{α}_{3}} {p}_{3}^{2 ( t + 2 )} \\ = {p}_{1}^{4} {p}_{1}^{{α}_{1} + 2 t} ⊕ {p}_{2}^{4} {p}_{1}^{{α}_{2}} {p}_{2}^{2 t} ⊕ {p}_{3}^{4} {p}_{1}^{{α}_{3}} {p}_{3}^{2 t} . \qquad Eq ( 4 )$$

Equation set (4) may be expressed in matrix form as follows:

$$( \begin{matrix}{x}_{1} \\ {x}_{2} \\ {x}_{3}\end{matrix} ) = ( \begin{matrix}1 & 1 & 1 \\ {p}_{1}^{2} & {p}_{2}^{2} & {p}_{3}^{2} \\ {p}_{1}^{4} & {p}_{2}^{4} & {p}_{3}^{4}\end{matrix} ) ( \begin{matrix}{p}^{{α}_{1} + 2 t} \\ {p}^{{α}_{2}} {p}_{2}^{2 t} \\ {p}_{1}^{{α}_{3}} {p}_{3}^{2 t}\end{matrix} ) = B ( \begin{matrix}{p}^{{α}_{1} + 2 t} \\ {p}_{1}^{{α}_{2}} {p}_{2}^{2 t} \\ {p}_{1}^{{α}_{3}} {p}_{3}^{2 t}\end{matrix} ) . \qquad Eq ( 5 )$$

The receiver may solve for terms p₁^{α}^{₁}^{+2t}, p₁^{α}^{₂}p₂^{2t} and p₁^{α}^{₃}p₃^{2t} in equation (5), as follows:

$$( \begin{matrix}{y}_{1} \\ {y}_{2} \\ {y}_{3}\end{matrix} ) = {B}^{- 1} ( \begin{matrix}{x}_{1} \\ {x}_{2} \\ {x}_{3}\end{matrix} ) = ( \begin{matrix}{p}^{{α}_{1} + 2 t} \\ {p}_{1}^{{α}_{2}} {p}_{2}^{2 t} \\ {p}_{1}^{{α}_{3}} {p}_{3}^{2 t}\end{matrix} ) . \qquad Eq ( 6 )$$

The receiver may obtain the exponent of p₁^{α}^{₁}^{+2t} as follows:

z₁=log(y₁)/log(p₁)=α₁+2t. Eq (7)

The logarithm in equation (7) is over field Z₄₇. The exponent factor α₁ and index t may be obtained from equation (7), as follows:

α₁=z₁ mod 2, and Eq (8a)

t=z₁ div 2. Eq (8b)

Factor α₂ may be determined by substituting t obtained from equation (8b) into y₂=p₁^{α}^{₂}p₂^{2t} to obtain p₁^{α}^{₂}, and then solving for α₂ based on p₁^{α}^{₂}. Similarly, factor α₃ may be determined by substituting t into y₃=p₁^{α}^{₃}p₃^{2t} to obtain p₁^{α}^{₃}, and then solving for α₃ based on p₁^{α}^{₃}.

An example beacon code based on a Reed-Solomon code has been described above. Other beacon codes may also be used to send beacon information in beacon symbols. In general, a transmitter may process beacon information based on a beacon code to generate a sequence of non-binary symbols. The transmitter may send a sufficient number of non-binary symbols in the sequence, one or more non-binary symbols in each beacon symbol. The number of non-binary symbols to send may be dependent on the beacon code, the beacon information being sent, etc.

A receiver may receive one or more beacon symbols from the transmitter and may determine the received power of each subcarrier in each beacon symbol. The receiver may recover the beacon information sent by the transmitter using hard-decision decoding and/or soft-decision decoding. For hard-decision decoding, the receiver may first determine the beacon subcarriers for each beacon symbol. For each beacon symbol, the receiver may compare the received power of each subcarrier against a threshold and may declare a beacon subcarrier if the received power exceeds the threshold. The threshold may be determined based on the total received power, the transmit power used for each beacon subcarrier, the transmit power used for each remaining subcarrier, etc. The receiver may detect M beacon subcarriers for each beacon symbol and may obtain one or more non-binary symbols for the M beacon subcarriers. The receiver may then decode all non-binary symbols to recover the beacon information.

For soft-decision decoding, the receiver may first determine the total received power for each possible message that can be sent by the transmitter for the beacon information. For each possible message, the receiver may coherently or non-coherently combine the received powers of all beacon subcarriers (in one or more beacon symbols) for that message to obtain the total received power for the message. The receiver may obtain Q total received powers for Q possible messages, where Q may be equal to 4096 for 12-bit messages. In one design, the receiver may identify the message with the largest total received power and may provide this message as a decoded message if its total received power is above a threshold. The receiver may obtain at most one decoded message for this design. In another design, the receiver may compare the total received power for each message against the threshold and may provide the message as a decoded message if its total received power is above the threshold. The receiver may obtain zero, one, or more decoded messages for this design.

The receiver may also use a combination of hard-decision and soft-decision decoding. For example, the receiver may first perform hard-decision decoding and obtain a detected message. The receiver may then compare the total received power of the beacon subcarriers for this detected message against a threshold. The receiver may provide the detected message as a decoded message if the total received power exceeds the threshold.

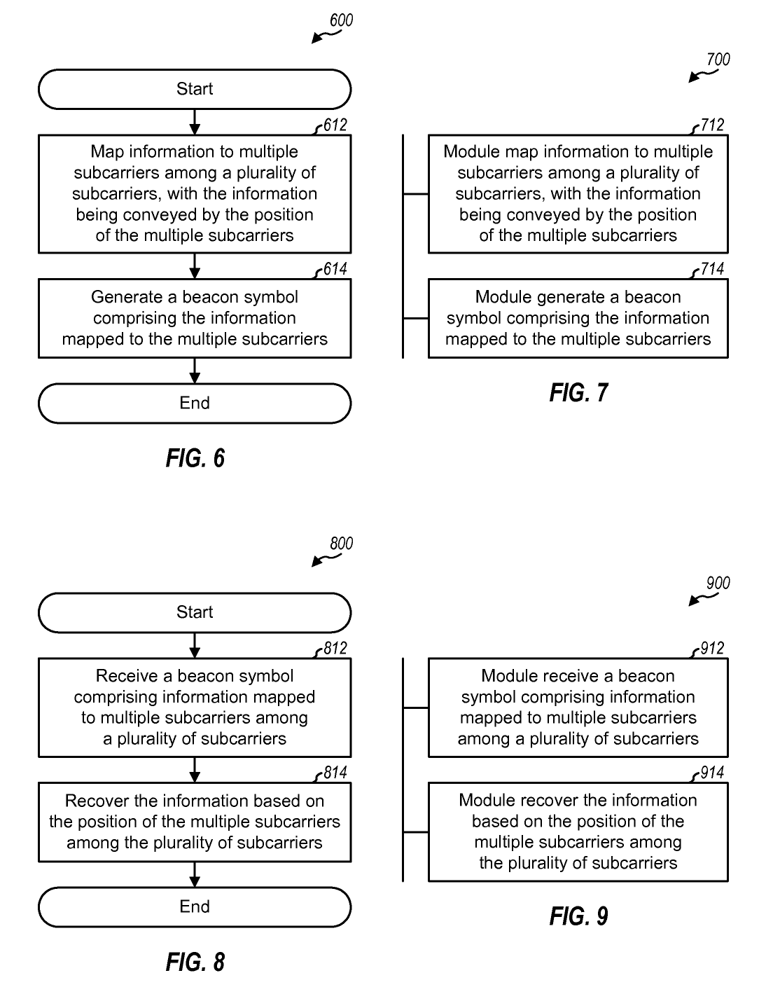

FIG. 6 shows a design of a process 600 for transmitting information in a wireless communication system. Process 600 may be performed by a transmitter, which may be a base station, a terminal, or some other entity. The transmitter may map information (e.g., a cell ID, a sector ID, and/or other information) to multiple subcarriers among a plurality of subcarriers, with the information being conveyed by the position of the multiple subcarriers (block 612). In one design, each of the multiple subcarriers may be in one of multiple segments comprising non-overlapping sets of subcarriers, e.g., as shown in FIG. 2. In another design, each subcarrier may be any one of the plurality of subcarriers, e.g., as shown in FIG. 3. In any case, the transmitter may generate a beacon symbol comprising the information mapped to the multiple subcarriers (block 614).

In one design, the transmitter may map the information to at least one non-binary symbol. The transmitter may then determine the multiple subcarriers based on the at least one non-binary symbol. In one design, the transmitter may determine each of the multiple subcarriers based on a different non-binary symbol. In another design, the transmitter may determine the multiple subcarriers based on one non-binary symbol. The transmitter may also determine the multiple subcarriers in other manners.

The transmitter may map additional information to at least one subcarrier among the remaining subcarriers not used for the multiple subcarriers, e.g., as shown in FIG. 5. The transmitter may generate the beacon symbol further comprising the additional information mapped to the at least one subcarrier

In one design, the transmitter may generate an OFDM symbol comprising multiple modulation symbols mapped to the multiple subcarriers. The transmitter may provide the OFDM symbol as the beacon symbol. The multiple modulation symbols may be selected to reduce PAPR of the beacon symbol. In another design, the transmitter may generate an SC-FDM symbol comprising multiple modulation symbols sent in the time domain on the multiple subcarriers. The transmitter may provide the SC-FDM symbol as the beacon symbol.

The transmitter may send at least one message in at least one beacon symbol. The transmitter may map each message to a respective set of non-binary symbols. The transmitter may determine the multiple subcarriers for each beacon symbol based on at least one non-binary symbol from the at least one set of non-binary symbols for the at least one message. The transmitter may send a single message in each beacon symbol. Alternatively, the transmitter may send multiple messages in each beacon symbol, e.g., each message may be sent on one subcarrier in each beacon symbol.

FIG. 7 shows a design of an apparatus 700 for transmitting information in a wireless communication system. Apparatus 700 includes a module 712 to map information to multiple subcarriers among a plurality of subcarriers, with the information being conveyed by the position of the multiple subcarriers, and a module 714 to generate a beacon symbol comprising the information mapped to the multiple subcarriers.

FIG. 8 shows a design of a process 800 for receiving information in a wireless communication system. Process 800 may be performed by a receiver, which may be a terminal, a base station, or some other entity. The receiver may receive a beacon symbol comprising information mapped to multiple subcarriers among a plurality of subcarriers (block 812). The receiver may recover the information based on the position of the multiple subcarriers among the plurality of subcarriers (block 814). In one design, the receiver may determine at least one non-binary symbol based on the position of the multiple subcarriers. The receiver may then decode the at least one non-binary symbol to recover the information. In another design, the receiver may determine multiple non-binary symbols based on the position of the multiple subcarriers, one non-binary symbol for each subcarrier. The receiver may then decode the multiple non-binary symbols to recover the information.

The beacon symbol may comprise additional information mapped to at least one subcarrier among the remaining subcarriers not used for the multiple subcarriers. The receiver may then recover the additional information based on at least one received symbol for the at least one subcarrier.

A transmitter may send at least one message on multiple subcarriers in each of at least one beacon symbol. Each message may be sent via a respective set of non-binary symbols. The receiver may recover the at least one message based on the non-binary symbols obtained from the at least one beacon symbol. In one design, the receiver may perform hard-decision decoding. The receiver may compare the received power of each of the plurality of subcarriers for each beacon symbol against a threshold and may identify the multiple subcarriers for that beacon symbol based on comparison results. The receiver may determine at least one non-binary symbol for each beacon symbol based on the position of the multiple subcarriers. The receiver may then decode all non-binary symbols to recover the at least one message. In another design, the receiver may perform soft-decision decoding. The receiver may determine the total received power for each possible message by combining the receive powers of all subcarriers used for that message. The receiver may then recover the at least one message based on the total received powers for all possible messages.

FIG. 9 shows a design of an apparatus 900 for receiving information in a wireless communication system. Apparatus 900 includes a module 912 to receive a beacon symbol comprising information mapped to multiple subcarriers among a plurality of subcarriers, and a module 914 to recover the information based on the position of the multiple subcarriers among the plurality of subcarriers.

The modules in FIGS. 7 and 9 may comprise processors, electronics devices, hardware devices, electronics components, logical circuits, memories, etc., or any combination thereof.

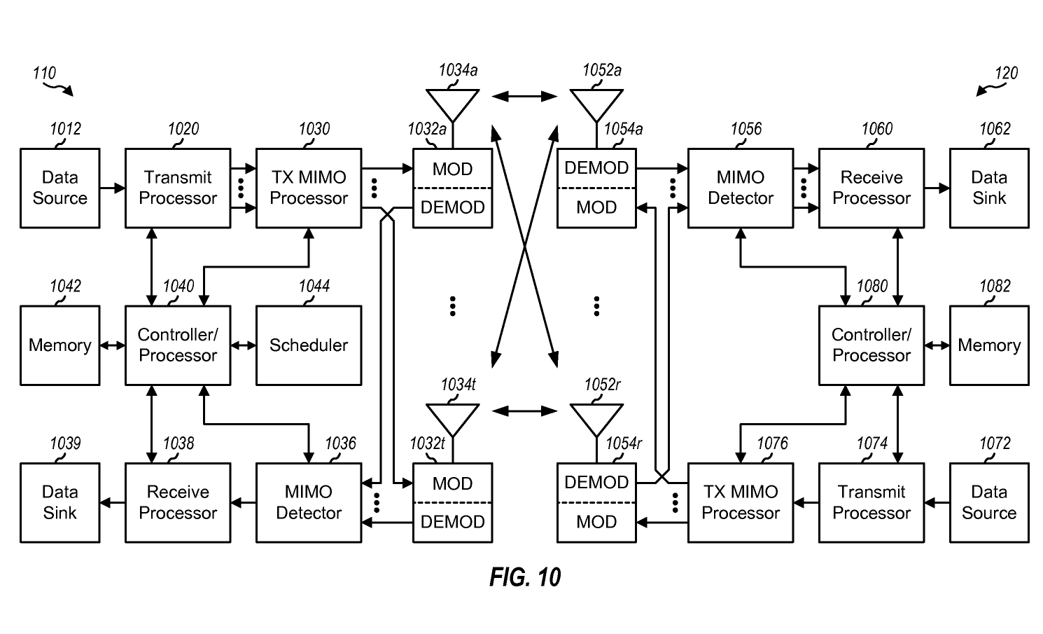

FIG. 10 shows a block diagram of a design of a base station 110 and a terminal 120, which may be one of the base stations and one of the terminals in FIG. 1. In this design, base station 110 is equipped with T antennas 1034a through 1034t, and terminal 120 is equipped with R antennas 1052a through 1052r, where in general T≧1 and R≧1.

At base station 110, a transmit processor 1020 may receive traffic data from a data source 1012 for one or more terminals, process the traffic data for each terminal based on one or more modulation and coding schemes, and provide data modulation symbols for all terminals. Transmit processor 1020 may also process beacon information and other information and provide control modulation symbols. A transmit (TX) multiple-input multiple-output (MIMO) processor 1030 may multiplex the data modulation symbols, the control modulation symbols, pilot symbols, and possibly other symbols. TX MIMO processor 1030 may perform spatial processing (e.g., preceding) on the multiplexed symbols, if applicable, and provide T output symbol streams to T modulators (MODs) 1032a through 1032t. Each modulator 1032 may process a respective output symbol stream (e.g., for OFDM, SC-FDM, etc.) to obtain an output sample stream. Each modulator 1032 may further process (e.g., convert to analog, amplify, filter, and upconvert) the output sample stream to obtain a forward link signal. T forward link signals from modulators 1032a through 1032t may be transmitted via T antennas 1034a through 1034t, respectively.

At terminal 120, antennas 1052a through 1052r may receive the forward link signals from base station 110 and may provide received signals to demodulators (DEMODS) 1054a through 1054r, respectively. Each demodulator 1054 may condition (e.g., filter, amplify, downconvert, and digitize) a respective received signal to obtain received samples. Each demodulator 1054 may further process the received samples (e.g., for OFDM, SC-FDM, etc.) to obtain received symbols. A MIMO detector 1056 may obtain received symbols from all R demodulators 1054a through 1054r, perform MIMO detection on the received symbols if applicable, and provide detected symbols. A receive processor 1060 may process (e.g., demodulate, deinterleave, and decode) the detected symbols, provide decoded traffic data for terminal 120 to a data sink 1062, and provide decoded beacon information and other information to a controller/processor 1080.

On the reverse link, at terminal 120, traffic data from a data source 1072 and control information from controller/processor 1080 may be processed by a transmit processor 1074, precoded by a TX MIMO processor 1076 if applicable, processed by modulators 1054a through 1054r (e.g., for OFDM, SC-FDM, etc.), and transmitted to base station 110. At base station 110, the reverse link signals from terminal 120 may be received by antennas 1034, demodulated by demodulators 1032, processed by a MIMO detector 1036 if applicable, and further processed by a receive processor 1038 to obtain the traffic data and control information transmitted by terminal 120.

Controllers/processors 1040 and 1080 may direct the operation at base station 110 and terminal 120, respectively. Controller/processor 1040 and/or 1080 may each perform or direct process 600 in FIG. 6, process 800 in FIG. 8, and/or other processes for the techniques described herein. Memories 1042 and 1082 may store data and program codes for terminal 120 and base station 110, respectively. A scheduler 1044 may schedule terminals for transmission on the forward and reverse links and may provide assignments of resources for the scheduled terminals.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of transmitting information in a wireless communication system, comprising:
mapping information to multiple subcarriers among a plurality of subcarriers, the information being conveyed by position of the multiple subcarriers; and
generating a beacon symbol comprising the information mapped to the multiple subcarriers.

2. The method of claim 1, wherein the mapping the information to the multiple subcarriers comprises
mapping the information to one subcarrier in each of multiple segments, the multiple segments comprising non-overlapping sets of subcarriers.

3. The method of claim 1, wherein the mapping the information to the multiple subcarriers comprises
mapping the information to at least one non-binary symbol, and
determining the multiple subcarriers based on the at least one non-binary symbol.

4. The method of claim 1, wherein the mapping the information to the multiple subcarriers comprises
mapping the information to multiple non-binary symbols, and
determining each of the multiple subcarriers based on a respective one of the multiple non-binary symbols.

5. The method of claim 1, wherein the mapping the information to the multiple subcarriers comprises
mapping at least one message to at least one set of non-binary symbols, one set of non-binary symbols for each message, and
determining the multiple subcarriers based on at least one non-binary symbol from the at least one set.

6. The method of claim 1, wherein the generating the beacon symbol comprises generating an orthogonal frequency division multiplex (OFDM) symbol comprising multiple modulation symbols mapped to the multiple subcarriers, the OFDM symbol being provided as the beacon symbol.

7. The method of claim 6, wherein the multiple modulation symbols are selected to reduce peak-to-average-power ratio (PAPR) of the beacon symbol.

8. The method of claim 1, wherein the generating the beacon symbol comprises generating a single-carrier frequency division multiplex (SC-FDM) symbol comprising multiple modulation symbols sent on the multiple subcarriers, the SC-FDM symbol being provided as the beacon symbol.

9. The method of claim 1, further comprising:
mapping additional information to at least one subcarrier among remaining subcarriers not used for the multiple subcarriers, and
wherein the generating the beacon symbol comprises generating the beacon symbol further comprising the additional information mapped to the at least one subcarrier.

10. The method of claim 1, wherein the information comprises a cell identifier (ID) or a sector ID.

11. An apparatus for wireless communication, comprising:
at least one processor configured to map information to multiple subcarriers among a plurality of subcarriers, the information being conveyed by position of the multiple subcarriers, and to generate a beacon symbol comprising the information mapped to the multiple subcarriers.

12. The apparatus of claim 11, wherein the at least one processor is configured to map the information to one subcarrier in each of multiple segments, the multiple segments comprising non-overlapping sets of subcarriers.

13. The apparatus of claim 11, wherein the at least one processor is configured to map the information to at least one non-binary symbol, and to determine the multiple subcarriers based on the at least one non-binary symbol.

14. The apparatus of claim 11, wherein the at least one processor is configured to map at least one message to at least one set of non-binary symbols, one set of non-binary symbols for each message, and to determine the multiple subcarriers based on at least one non-binary symbol from the at least one set.

15. An apparatus for wireless communication, comprising:
means for mapping information to multiple subcarriers among a plurality of subcarriers, the information being conveyed by position of the multiple subcarriers; and
means for generating a beacon symbol comprising the information mapped to the multiple subcarriers.

16. The apparatus of claim 15, wherein the means for mapping the information to the multiple subcarriers comprises
means for mapping the information to one subcarrier in each of multiple segments, the multiple segments comprising non-overlapping sets of subcarriers.

17. The apparatus of claim 15, wherein the means for mapping the information to the multiple subcarriers comprises
means for mapping the information to at least one non-binary symbol, and
means for determining the multiple subcarriers based on the at least one non-binary symbol.

18. The apparatus of claim 15, wherein the means for mapping the information to the multiple subcarriers comprises
means for mapping at least one message to at least one set of non-binary symbols, one set of non-binary symbols for each message, and
means for determining the multiple subcarriers based on at least one non-binary symbol from the at least one set.

19. A computer program product, comprising:
a computer-readable medium comprising:
code for causing at least one computer to map information to multiple subcarriers among a plurality of subcarriers, the information being conveyed by position of the multiple subcarriers, and
code for causing the at least one computer to generate a beacon symbol comprising the information mapped to the multiple subcarriers.

20. A method of receiving information in a wireless communication system, comprising:
receiving a beacon symbol comprising information mapped to multiple subcarriers among a plurality of subcarriers; and
recovering the information based on position of the multiple subcarriers among the plurality of subcarriers.

21. The method of claim 20, wherein each of the multiple subcarriers being in a different one of multiple segments, the multiple segments comprising non-overlapping sets of subcarriers.

22. The method of claim 20, wherein the recovering the information comprises
determining at least one non-binary symbol based on the position of the multiple subcarriers, and
decoding the at least one non-binary symbol to recover the information.

23. The method of claim 20, wherein the recovering the information comprises
determining multiple non-binary symbols based on the position of the multiple subcarriers, one non-binary symbol for each subcarrier, and
decoding the multiple non-binary symbols to recover the information.

24. The method of claim 20, wherein the recovering the information comprises
determining at least one non-binary symbol based on the position of the multiple subcarriers, and
recovering at least one message based on the at least one non-binary symbol, wherein each message is sent via a respective set of non-binary symbols, and wherein the at least one non-binary symbol comprises one or more non-binary symbols from each set of non-binary symbols.

25. The method of claim 20, wherein the recovering the information comprises
comparing received power of each of the plurality of subcarriers against a threshold,
identifying the multiple subcarriers based on comparison results,
determining at least one non-binary symbol based on the position of the multiple subcarriers, and
decoding the at least one non-binary symbol to recover the information.

26. The method of claim 20, wherein the recovering the information comprises
determining total received power for each of multiple possible messages by combining receive powers of subcarriers used for the message, and
determining the information based on total received powers for the multiple possible messages.

27. The method of claim 20, wherein the beacon symbol further comprises additional information mapped to at least one subcarrier among remaining subcarriers not used for the multiple subcarriers, and wherein the method further comprises
recovering the additional information based on at least one received symbol for the at least one subcarrier.

28. An apparatus for wireless communication, comprising:
at least one processor configured to receive a beacon symbol comprising information mapped to multiple subcarriers among a plurality of subcarriers, and to recover the information based on position of the multiple subcarriers among the plurality of subcarriers.

29. The apparatus of claim 28, wherein the at least one processor is configured to determine at least one non-binary symbol based on the position of the multiple subcarriers, and to decode the at least one non-binary symbol to recover the information.

30. The apparatus of claim 28, wherein the at least one processor is configured to determine at least one non-binary symbol based on the position of the multiple subcarriers, and to recover at least one message based on the at least one non-binary symbol, wherein each message is sent via a respective set of non-binary symbols, and wherein the at least one non-binary symbol comprises one or more non-binary symbols from each set of non-binary symbols.
